(19) United States
(12) Patent Application Publication
(10) Pub. No.: US 2024/0348660 A1
(43) Pub. Date: Oct. 17, 2024

(54) Hardware-based Zero Trust Network Access Agent for Improved Security

(71) Applicant: Intel Corporation, Santa Clara, CA (US)

(72) Inventors: Omer Ben-Shalom, Rishon Le-Tzion (IL); Dan Horovitz, Rishon Le-Tzion (IL); Ilil Blum Shem-Tov, Kiryat Tivon (IL); Lev Faerman, Ramat Gan (IL); Wissam Ghammashi, Carmiel (IL)

(21) Appl. No.: 18/752,420

(22) Filed: Jun. 24, 2024

Related U.S. Application Data
(60) Provisional application No. 63/566,073, filed on Mar. 15, 2024.

(51) Int. Cl. H04L 9/40

(52) U.S. Cl. CPC H04L 63/20; H04L 63/0236; H04L 63/1416; H04L 63/306

(57) ABSTRACT

Hardware-based Zero Trust Network Access Agents for Improved Security are disclosed herein. An example apparatus includes network interface circuitry; machine-readable instructions; and first processor circuitry programmable by the instructions to detect, via firmware execution, a request from a device to access a resource via a zero trust network access interface; determine, via the firmware execution, a security state of the device; and based on the security state of the device, transmit the request to a host operating system (OS) via a virtual network interface, the operating system executed via second processor circuitry different than the first processor circuitry.

### RELATED APPLICATION

This patent claims the benefit of U.S. Provisional Patent Application No. 63/566,073, which was filed on Mar. 15, 2024. U.S. Provisional Patent Application No. 63/566,073 is hereby incorporated herein by reference in its entirety. Priority to U.S. Provisional Patent Application No. 63/566,073 is hereby claimed.

### BACKGROUND

Organizations often enable employees or other authorized users to remotely and securely access resources (e.g., applications, sensitive data, and services) of the organization. Zero Trust Network Access (ZTNA) is one known information technology (IT) security solution that enables users to securely access an organization's applications. Unlike alternative architectures like virtual private networks (VPNs), ZTNA only grants endpoint users access to specific services or applications, while VPNS grant access to entire networks. Thus, ZTNA eliminates unauthorized lateral movement within a network. As the number of employees working from home and remote access of organizational resources (e.g., enterprise resources, resources) increases, ZTNA solutions are increasingly important in reducing security risks associated with remote access of sensitive resources by reducing the digital attack surface.

### BRIEF DESCRIPTION OF THE DRAWINGS

FIG. 1 is a block diagram of an example environment in which an example hardware-based ZTNA agent operates to perform validation and authentication.

FIG. 2 is a block diagram of an example implementation of the hardware-based ZTNA agent of FIG. 1.

FIG. 3 is a flow diagram illustrating example communication network between the hardware-based ZTNA agent of FIG. 1 and an enterprise, untrusted destination, and trusted destination.

FIG. 4 is a flowchart representative of example machine readable instructions and/or example operations that may be executed, instantiated, and/or performed by example programmable circuitry to implement the hardware-based ZTNA agent 101 of FIG. 2.

FIG. 5 is another flowchart representative of example machine readable instructions and/or example operations that may be executed, instantiated, and/or performed by example programmable circuitry to implement the hardware-based ZTNA agent 101 of FIG. 2.

FIG. 6 is a block diagram of an example processing platform including programmable circuitry structured to execute, instantiate, and/or perform the example machine readable instructions and/or perform the example operations of FIGS. 4-5 to implement the hardware-based ZTNA agent 101 of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

ZTNA encompasses a range of computing technologies for verifying a requesting user or device and providing access according to predefined policies. One use case of ZTNA utilizes a software-based agent provided by a third-party vendor for installation on a client endpoint device. These local software agents facilitate validation of the user and the device and control of routing and local policies. The local software agents also tunnel part or all the traffic to a ZTNA point of presence (POP).

ZTNA local software agents are often implemented by the main operating system (OS) of the endpoint devices. As such, the local software agents are vulnerable to tampering and exploitation if the OS on which they are implemented is compromised. In other words, existing ZTNA agents are subject to malicious OS-level attacks. As used herein, a “malicious” attack is any type of software attack, unauthorized access, exploit, etc. designed to cause harm or damage to a computer, server, client, computer network, data, infrastructure, etc. Example malicious attacks include viruses, worms, trojans, hybrid malware, spyware, etc. Such attacks can lead to bypass of network controls, data exfiltration, and other security challenges. Furthermore, software-based agents require full administrative control over the OS to install the agent and to allow the software agent system level visibility for device posture checking, routing controls, and more. Furthermore, software-based agents significantly limit the ZTNA system's value for devices that are not owned by the organization or for devices with OSs that do not support the agents and/or devices without an OS.

Systems, methods, and apparatus disclosed herein provide for a ZTNA agent at least partially implemented below an operating system (e.g., implemented at least partially by hardware and/or firmware) for improved security by reducing the digital attack surface of the ZTNA architecture. Hardware-based ZTNA agents disclosed herein implement the ZTNA agent functionality below the OS and using platform hardware resources, such as, but not limited to, a network interface card (NIC) with a compute complex (e.g., smart NIC (sNIC), foundational Ethernet NIC (fNIC), infrastructure processing unit (IPU), data processing unit (DPU), INTEL® Trust Domain Extensions (TDX), INTEL® AI-NIC, embedded secure element (ESE), etc.). Disclosed systems, methods, and apparatus allow for Zero trust access to private applications, protecting data and resources with application-level access control based on user identity, authorization, and security posture. Hardware-based ZTNA agents disclosed herein may reduce the digital attack surface, ensuring that applications hosted in public clouds and private data centers are never exposed to the internet. Disclosed systems, methods, and apparatus may eliminate the need for hosting applications in the DMZ or maintaining public facing services such as VPN. Disclosed methods and apparatus provide for a ZTNA agent with core functionality implemented below the OS, providing improved protection from OS attackers and improving performance and connectivity compared to existing solutions.

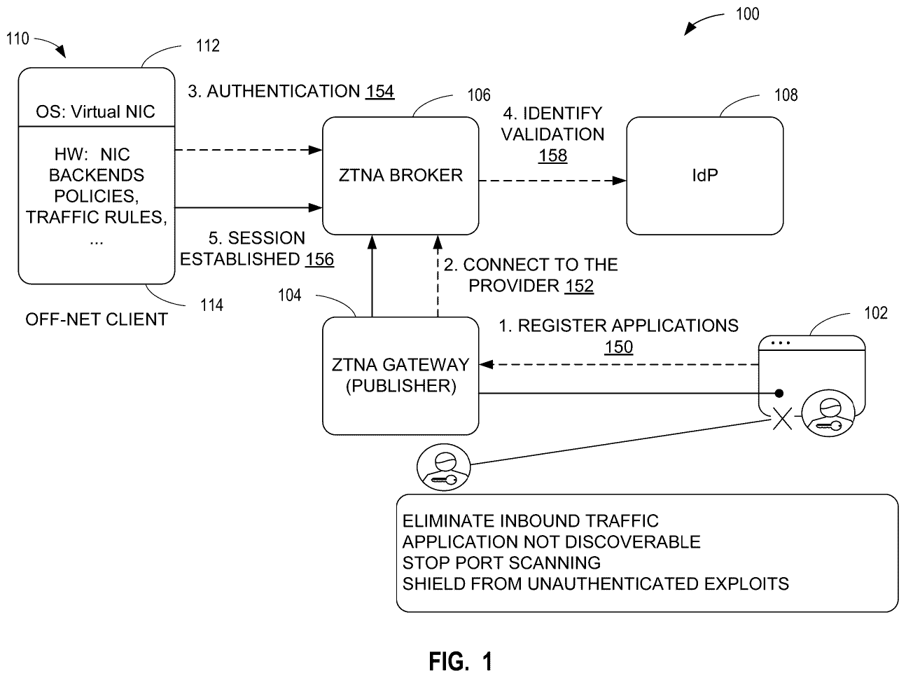

FIG. 1 is a block diagram of an example environment 100 in which an example hardware-based ZTNA agent 101 operates to perform validation and authentication of the hardware ZTNA enabled device 110. The example environment 100 includes enterprise resource 102 (e.g., an application, data, privileges, etc.) hosted by an organization 20 (not shown), an example ZTNA gateway 104, an example ZTNA Broker 106, an example identity provider (IdP) 108, and an example hardware ZTNA enabled device 110.

The example ZTNA gateway 104 is a computing device such as a server, a personal computer, a workstation, a mobile device, or any other type of computing device. In other examples, the ZTNA gateway 104 is network equipment (such as a router, switch, or an access point), a website or a mobile application, a server or a service, an entity, an application, and/or any other device or entity that enables connections between authorized parties. The ZTNA gateway 104 establishes connections between the enterprise resource 102 and authorized parties.

The example ZTNA broker 106 (e.g., ZTNA provider, ZTNA backend, etc.) is a computing device such as a server, a personal computer, a workstation, a mobile device, or any other type of computing device. In other examples, the ZTNA broker 106 is network equipment (such as a router, switch, or an access point), a website or a mobile application, a server or a service, an entity, an application, and/or any other device or entity that controls access to enterprise resource 102. The ZTNA broker 106 restricts access to enterprise resource 102 to authorized parties.

The example IdP 108 is a computing device such as a server, a personal computer, a workstation, a mobile device, or any other type of computing device. In other examples, the IdP 108 is network equipment (such as a router, switch, or an access point), a website or a mobile application, a server or a service, an entity, an application, and/or any other device or entity that retains records pertaining to the identities of authorized users. The IdP 108 retains identification records of users and devices authorized to access the enterprise resource 102 and makes the identification records accessible by the ZTNA broker 106.

The hardware ZTNA enabled device 110 is a computing device such as a server, a personal computer, a workstation, a mobile device, or any other type of computing device that can implement the hardware-based ZTNA agent 101. The hardware ZTNA enabled device 110 includes an OS 112 implemented by processor circuitry and a ZTNA NIC 114. In other examples, the hardware enabled device 110 includes a sNIC, fNIC, IPU, DPU, TDX, AI-NIC, ESE, an Application-Specific Integrated Circuit, an XPU, a Field-Programmable Gate Array, and other any other processor circuitry and/or combination of processor circuitries, instead of, or in addition to the ZTNA NIC 114.

FIG. 1 also illustrates an example communication flow in the environment 100. An organization determines that example enterprise resource 102 may only be accessed by authorized users. At 150, the organization registers the enterprise resource 102 with the ZTNA gateway 104. At 152, the Enterprise resource 102 are connected to the ZTNA broker 106. The organization sets policies with the ZTNA broker 106 identifying a variety of limitations on the access of the enterprise resource 102. For example, the policies may identify authorized endpoint users, set evaluation criteria for allowable security states of the hardware ZTNA enabled device 110, and/or limit a user's access to the enterprise resource 102 to a certain time of day or for a duration of time.

The hardware ZTNA enabled device 110 attempts to access the enterprise resource 102. At 154, the ZTNA broker 154 performs authentication/validation of the hardware ZTNA enabled device 110 and a user of the hardware ZTNA enabled device 110. At 158, the ZTNA broker 106 communicates with the IdP 108 to access identification records. The ZTNA broker 106 uses the identification records to perform identity validation of the hardware ZTNA enabled device 110 and a user of the hardware ZTNA enabled device 110. Once the ZTNA broker 106 finishes performing all the stuff, the ZTNA broker establishes a session for the hardware ZTNA enabled device 110. The ZTNA gateway 104 is responsible for creating a communication path between the enterprise resource and the ZTNA broker 106, as well as a communication path between the enterprise resource 102 and the hardware ZTNA enabled device 110. The ZTNA gateway 104 enables the hardware ZTNA enabled device 110 to access to the enterprise resource 102 once it has been determined the hardware ZTNA enabled device 110 is authorized to access the enterprise resource 102.

The ZTNA broker 106 ensures that connections are only made between authorized parties. In some cases, the ZTNA broker 106 authenticates the hardware ZTNA enabled device 110 and or the user of the hardware ZTNA enabled device 110 and returns an allowed list of enterprise resource 102 to the hardware ZTNA enabled device 110. In the example environment 100 of FIG. 1, the ZTNA broker 106 performs authentication of the hardware ZTNA enabled device 110 and/or the user of the hardware ZTNA enabled device 110 based on identity records maintained by the IdP 108. The ZTNA broker 106 establishes a connection between the hardware ZTNA enabled device 110 and the enterprise resource 102 via the ZTNA gateway 104.

The hardware ZTNA enabled device 110 implements the hardware-based ZTNA agent 101. In the illustrated example of FIG. 1, the hardware-based ZTNA agent is implemented by the ZTNA NIC 114. In some examples, the hardware-based ZTNA agent 101 is implemented by a sNIC, fNIC, IPU, DPU, TDX, AI-NIC, ESE, an Application-Specific Integrated Circuit, an XPU, a Field-Programmable Gate Array, and other any other processor circuitry and/or combination of processor circuitries. In some examples, the hardware-based ZTNA agent 101 is implemented by the execution of firmware.

The example hardware ZTNA enabled device 110 requests access to the enterprise resource 102 from the ZTNA broker 106. In some examples, the hardware ZTNA enabled device 110 access to the enterprise resource 102 via a ZTNA interface which the hardware-based ZTNA agent 101 causes to be displayed by the hardware ZTNA enabled device 110. The hardware-based ZTNA agent 101 performs validation of the hardware ZTNA enabled device 110 and/or the user of the hardware ZTNA enabled device 110, controls routing of traffic between the hardware ZTNA enabled device 110 and the ZTNA gateway 104 and/or ZTNA broker 106, applies local policies, and tunnels part or all traffic to the ZTNA broker 106. In some examples, the hardware-based ZTNA agent 101 exposes a virtual network interface into the operating system of the hardware ZTNA enabled device 110. The hardware-based ZTNA agent 101 detects a request by the hardware ZTNA enabled device 110 to access the enterprise resource 102. In some examples, the hardware-based ZTNA agent 101 determines a security state (e.g., a security posture, an operating state) of the hardware ZTNA enabled device 110 and or the host OS. Based on the determined security state, the hardware-based ZTNA agent 101 transmits the request to a host OS of the hardware ZTNA enabled device 110 via the virtual network interface. In some examples, the hardware-based ZTNA agent 101 processes network communication directed to and from the host OS. In some examples, the virtual network interface primarily controls all or substantially all traffic directed to and from the host OS.

In some examples, the hardware-based ZTNA agent 101 enforces a security policy from the ZTNA broker 106 to control traffic to and from the host OS. If the hardware-based ZTNA agent 101 determines the security state of the hardware ZTNA enabled device 110 is unacceptable according to a security policy, the hardware-based ZTNA agent 101 restricts traffic directed to and from the host OS. In some examples, the hardware-based ZTNA agent 101 allows a first portion of traffic from the hardware ZTNA enabled device 110 to flow to the host OS via the virtual network interface and performs a security inspection of a second portion of traffic from the hardware ZTNA enabled device 110. In some examples, the hardware-based ZTNA agent 101 forwards a first portion of traffic from the local host while a second portion of the traffic is forwarded to the ZTNA broker 106 for deeper inspection/policy/controls.

In some examples, the hardware-based ZTNA agent 101 performs all ‘underlay’ network functionality such as dynamic host configuration protocol (DHCP), address resolution protocol (ARP) and the ability to connect to Hotspot 2.0 and other hot spots versions. In some examples, the hardware-based ZTNA agent 101 enforces connections to the ZTNA broker 106 for all traffic types. In some examples, the hardware-based ZTNA agent 101 accepts policies from the ZTNA broker 106 to allow specific other trusted destinations (e.g. office 365) without going through the ZTNA broker 106. In some examples, hardware-based ZTNA agent 101 only allows traffic flows over secured connection (ex: transport layer security (TLS), internet protocol security (IPSEC)) to specific approved locations by tracking establishment of connections and only allowing creation of sessions to ZTNA brokers 106 that use, as part of the session establishment, trusted and permitted certificates as defined by policy (e.g. defined by certificate authority (CA) hash, object identifier (OID), specific subjects). In those examples, the hardware-based ZTNA agent drops all traffic that isn't IPSEC/TLS. Traffic other than an initial connection to the web will either go to the ZTNA broker 106, the ZTNA gateway 104, or other trusted destinations.

The hardware-based ZTNA agent 101 provides an underlay network and an overlay network. As used herein, the “underlay” is the standard, existing network of the ZTNA architecture. As used herein, the “overlay” is a virtual network provided through the ZTNA gateway 104. Decompiling the overlay network from the underlay network provides consistent network addressing/forwarding and traffic control and can support features such as: trusted entity mutual validation between client and service provider, and endpoint posture validation. In some examples, the hardware-based ZTNA agent 101 re-routes at least a portion of traffic to the ZTNA broker 106 for its decision based on policy or other methods. In some examples, the hardware-based ZTNA agent 101 performs traffic filtering, such as dropping traffic that isn't covered in a ZTNA policy). The hardware-based ZTNA agent 101 enables the ZTNA broker 106 to set up the ZTNA policy. The ZTNA policy may require encrypted communication (e.g., TLS, signature-based verification, only certificates values). In some examples, the hardware-based ZTNA agent 101 may be capable of integrating different types of IdPs for use with multi-factor authentication (MFA).

In some examples, the hardware ZTNA enabled device 110 has two modes: a secured mode for enterprise workloads and a non-secured mode for general usages. The secured mode is enforced per policy not controlled by the user-defined by enterprise security policy. In the non-secured mode, the hardware-based ZTNA agent 101 blocks or redirects externally all other traffic based on predefined policy. In some examples, the hardware-based ZTNA agent 101 may enable users to access internal resources securely without additional VPN connections, whether users are located within the corporate network in HQ or located remotely. In some examples, the hardware-based ZTNA agent 101 may allow users to securely access resources through an SSL encrypted access proxy.

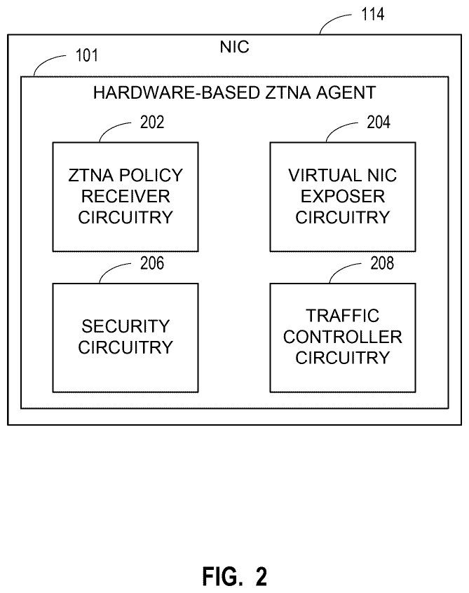

FIG. 2 is a block diagram of an example implementation of the hardware-based ZTNA agent 101 of FIG. 1 to provide ZTNA agent functionality below the OS of the hardware ZTNA enabled device 110. The hardware-based ZTNA agent 101 of FIG. 2 may be instantiated (e.g., creating an instance of, bring into being for any length of time, materialize, implement, etc.) by interface circuitry such as a NIC, sNIC, fNIC, IPU, DPU, TDX, AI-NIC, ESE, etc. Additionally or alternatively, the hardware-based ZTNA agent 101 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the hardware-based ZTNA agent 101 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The example hardware-based ZTNA agent 101 of the illustrated example of FIG. 2 includes example ZTNA policy receiver circuitry 202, example virtual NIC exposer circuitry 204, example security circuitry 206, and example traffic controller circuitry 208.

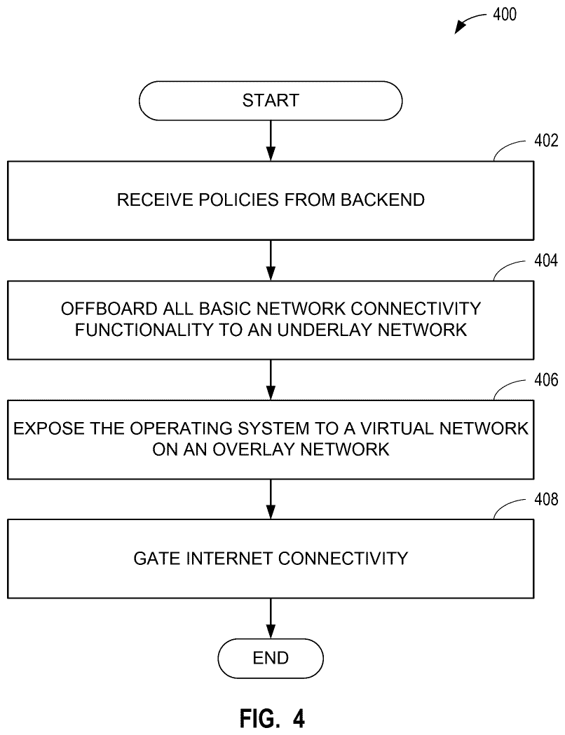

The ZTNA policy receiver circuitry 202 receives ZTNA policies from the ZTNA broker 106. The ZTNA policies may identify trusted destinations, set traffic filtering rules, set evaluation criteria for allowable security states, limit a user's access to the enterprise resource 102 to a certain time of day or for a duration of time, etc. In some examples, the ZTNA policy receiver circuitry 202 is instantiated by programmable circuitry executing ZTNA policy receiver instructions and/or configured to perform operations such as those represented by the flowchart of FIG. 4.

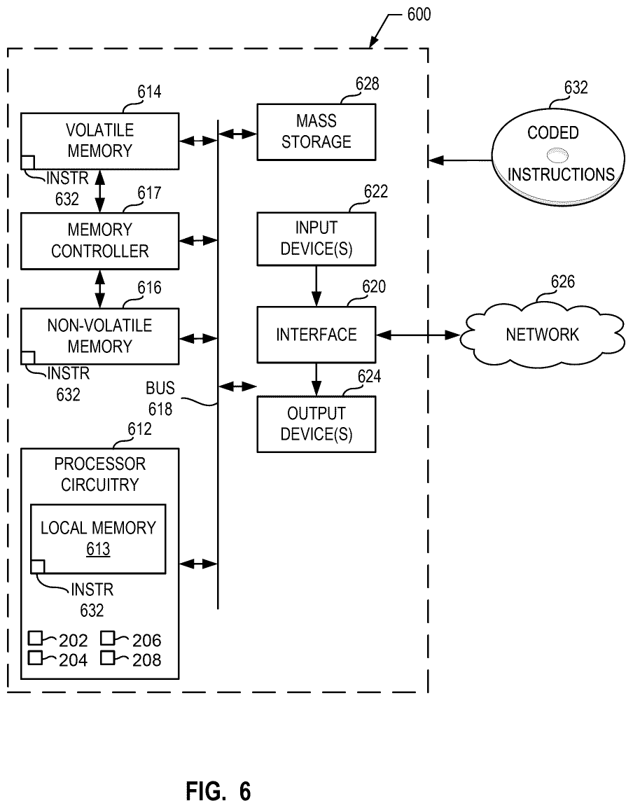

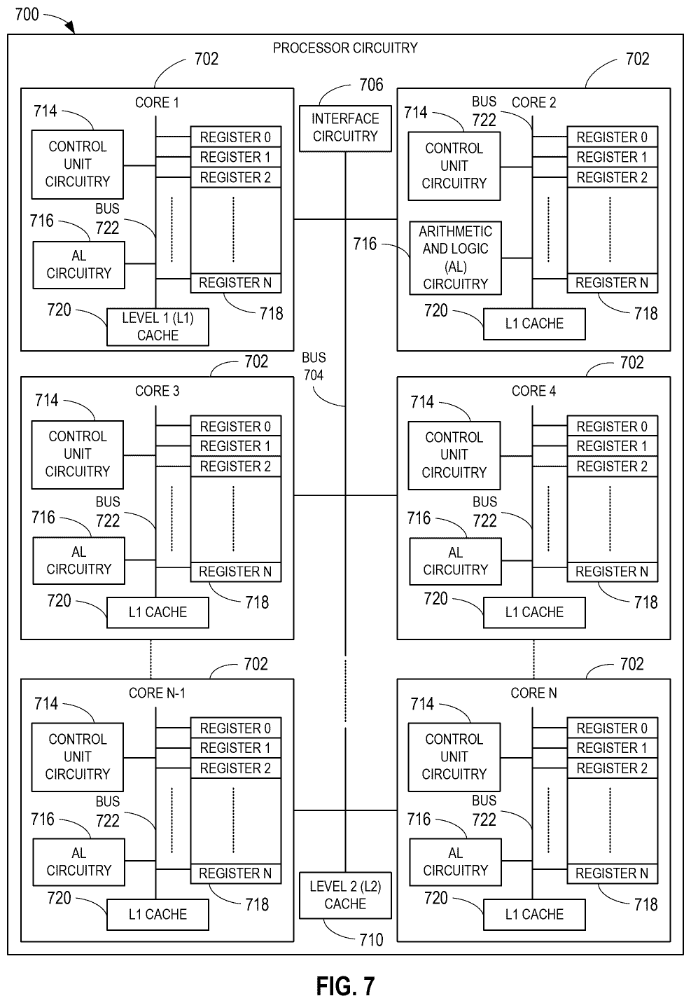

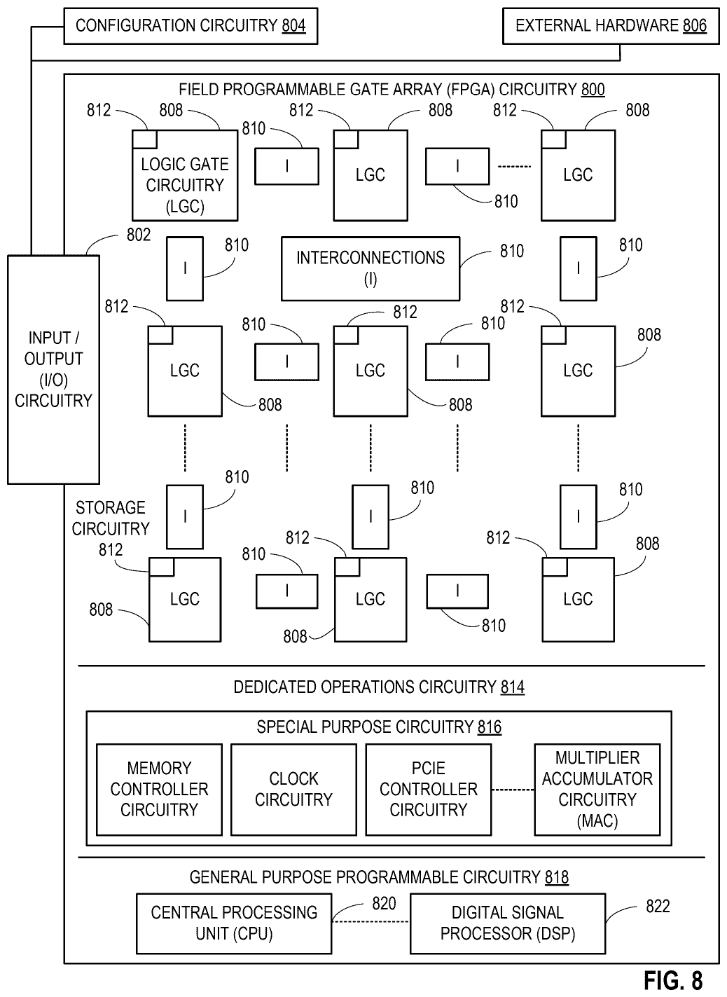

In some examples, the hardware-based ZTNA agent 101 includes means for receiving ZTNA policies. For example, the means for receiving may be implemented by ZTNA policy receiver circuitry 202. In some examples, the ZTNA policy receiver circuitry 202 may be instantiated by programmable circuitry such as the example programmable circuitry 612 of FIG. 6. For instance, the ZTNA policy receiver circuitry 202 may be instantiated by the example microprocessor 700 of FIG. 7 executing machine executable instructions such as those implemented by at least block 402 of FIG. 4. In some examples, ZTNA policy receiver circuitry 202 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the ZTNA policy receiver circuitry 202 may be instantiated by any other combination of hardware, software, and/or firmware. For example, the ZTNA policy receiver circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The virtual NIC exposer circuitry 204 exposes a virtual network interface into the OS of the hardware ZTNA enabled device 110. The virtual network interface is used by the OS and software of the hardware ZTNA enabled device 110. In some examples, the virtual NIC exposer circuitry 204 is instantiated by programmable circuitry executing virtual NIC exposer instructions and/or configured to perform operations such as those represented by the flowchart of FIG. 4.

In some examples, the hardware-based ZTNA agent 101 includes means for exposing a virtual NIC. For example, the means for exposing may be implemented by virtual NIC exposer circuitry 204. In some examples, the virtual NIC exposer circuitry 204 may be instantiated by programmable circuitry such as the example programmable circuitry 612 of FIG. 6. For instance, the virtual NIC exposer circuitry 204 may be instantiated by the example microprocessor 700 of FIG. 7 executing machine executable instructions such as those implemented by at least block 406 of FIG. 4. In some examples, virtual NIC exposer circuitry 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the virtual NIC exposer circuitry 204 may be instantiated by any other combination of hardware, software, and/or firmware. For example, the virtual NIC exposer circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security circuitry 206 receives ZTNA policies from the ZTNA broker 106. The security circuitry 206 performs validation of the hardware ZTNA enabled device 110 and/or the user of the hardware ZTNA enabled device 110. In some examples, the security circuitry 206 determines a security state (e.g., a security posture, an operating state) of the hardware ZTNA enabled device 110 and or the host OS. Based on the determined security state, the security circuitry instructs the traffic controller circuitry 208 how to process the traffic. For example, if the security state is acceptable according to policy, the security circuitry 206 instructs the traffic controller circuitry 208 to transmit the request to a host OS of the hardware ZTNA enabled device 110 via the virtual network interface. If the security circuitry 206 determines the security state of the hardware ZTNA enabled device 110 is unacceptable according to policy, the security circuitry 206 instructs the traffic controller circuitry 208 to restrict traffic directed to and from the host OS. In some examples, the security circuitry 206 allows a first portion of traffic from the hardware ZTNA enabled device 110 to flow to the host OS via the virtual network interface and performs a security inspection of a second portion of traffic from the hardware ZTNA enabled device 110.

In some examples, the security circuitry 206 is instantiated by programmable circuitry executing security instructions and/or configured to perform operations such as those represented by the flowchart of FIG. 4.

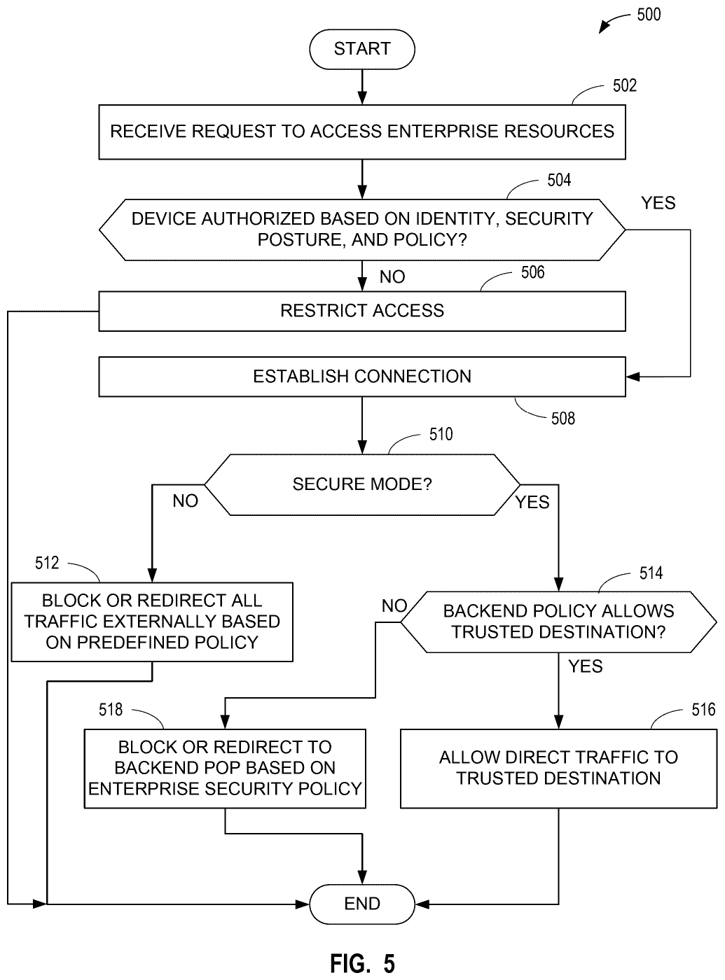

In some examples, the hardware-based ZTNA agent 101 includes means for securing. For example, the means for securing may be implemented by security circuitry 206. In some examples, the security circuitry 206 may be instantiated by programmable circuitry such as the example programmable circuitry 612 of FIG. 6. For instance, the security circuitry 206 may be instantiated by the example microprocessor 700 of FIG. 7 executing machine executable instructions such as those implemented by at least blocks 502 and 504 of FIG. 5. In some examples, the security circuitry 206 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the security circuitry 206 may be instantiated by any other combination of hardware, software, and/or firmware. For example, the security circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The traffic controller circuitry 208 controls routing of traffic between the hardware ZTNA enabled device 110 and the ZTNA gateway 104 and/or ZTNA broker 106, applies local policies, and tunnels part or all traffic to the ZTNA broker 106. In some examples, the traffic controller circuitry 208 enforces a security policy to control traffic to and from the host OS. In some examples, the traffic controller circuitry 208 forwards a first portion of traffic from the local host while a second portion of the traffic is forwarded to the ZTNA broker 106 for deeper inspection/policy/controls.

In some examples, the traffic controller circuitry 208 performs all ‘underlay’ network functionality such as dynamic host configuration protocol (DHCP), address resolution protocol (ARP) and the ability to connect to Hotspot 2.0 and other hot spots versions. In some examples, the traffic controller circuitry 208 enforces connections to the ZTNA broker 106 for all traffic types. In some examples, the traffic controller circuitry 208 accepts policies from the ZTNA broker 106 to allow specific other trusted destinations (e.g. office 365) without going through the ZTNA broker 106. In some examples, the traffic controller circuitry 208 only allows traffic flows over secured connection (ex: TLS, IPSEC) to specific approved locations by tracking establishment of connections and only allowing creation of sessions to ZTNA brokers 106 that use, as part of the session establishment, trusted and permitted certificates as defined by policy (e.g. defined by CA hash, OID, specific subjects).

The traffic controller circuitry 208 provides an underlay network and an overlay network. In some examples, the traffic controller circuitry 208 re-routes at least a portion of traffic to the ZTNA broker 106 for its decision based on policy or other methods. In some examples, the traffic controller circuitry 208 performs traffic filtering, such as dropping traffic that isn't covered in a ZTNA policy). The ZTNA policy may require encrypted communication (e.g., TLS, signature-based verification, only certificates values). In some examples, the traffic controller circuitry 208 is instantiated by programmable circuitry executing traffic controller instructions and/or configured to perform operations such as those represented by the flowchart of FIG. 4.

In some examples, the hardware-based ZTNA agent 101 includes means for controlling traffic. For example, the means for controlling may be implemented by traffic controller circuitry 208. In some examples, the traffic controller circuitry 208 may be instantiated by programmable circuitry such as the example programmable circuitry 612 of FIG. 6. For instance, the traffic controller circuitry 208 may be instantiated by the example microprocessor 700 of FIG. 7 executing machine executable instructions such as those implemented by at least blocks 404, 408, 506, 508, 510, 512, 514, 516, and 518 of FIGS. 4-5. In some examples, the traffic controller circuitry 208 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the traffic controller circuitry 208 may be instantiated by any other combination of hardware, software, and/or firmware. For example, the traffic controller circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the hardware-based ZTNA agent 101 of FIG. 1 is illustrated in FIG. 2, one or more of the elements, processes, and/or devices illustrated in FIG. 2 may be combined, divided, re-arranged, omitted, eliminated, and/or implemented in any other way. Further, the ZTNA policy receiver circuitry 202, the virtual NIC exposer circuitry 204, the security circuitry 206, and the traffic controller circuitry 208, and/or, more generally, the example hardware-based ZTNA agent 101 of FIG. 2, may be implemented by hardware alone or by hardware in combination with software and/or firmware. Thus, for example, any of the ZTNA policy receiver circuitry 202, the virtual NIC exposer circuitry 204, the security circuitry 206, and the traffic controller circuitry 208, and/or, more generally, the example hardware-based ZTNA agent 101, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example hardware-based ZTNA agent 101 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the hardware-based ZTNA agent 101 of FIG. 2 and/or representative of example operations which may be performed by programmable circuitry to implement and/or instantiate the hardware-based ZTNA agent 101 of FIG. 2, are shown in FIGS. 4-5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 4-5, many other methods of implementing the example hardware-based ZTNA agent 101 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

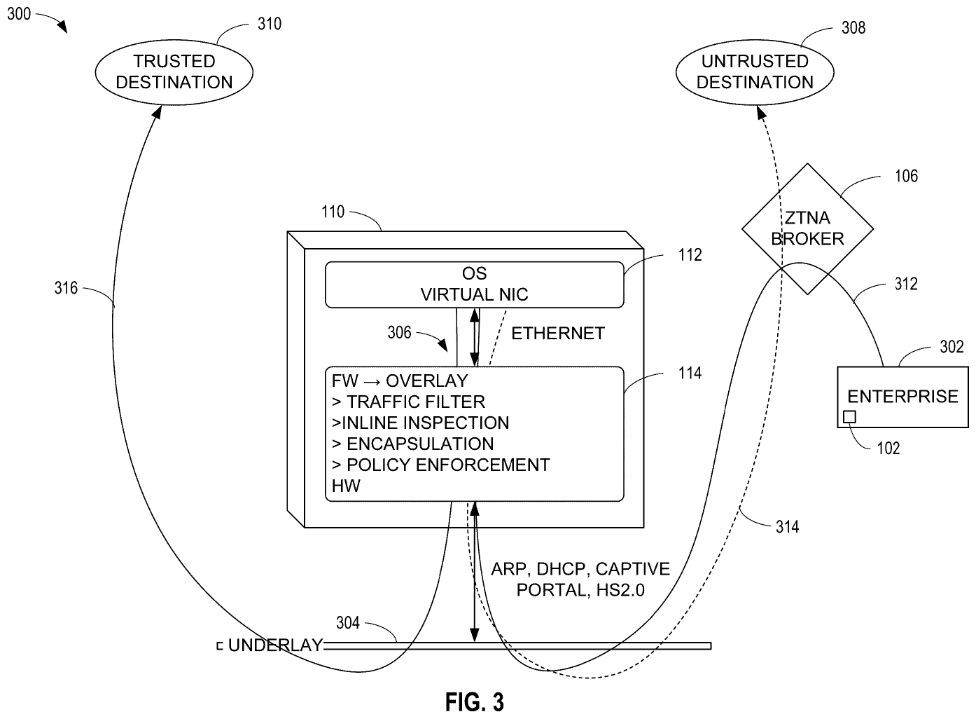

FIG. 3 is a flow diagram illustrating example communication network 300 between the hardware ZTNA enabled device 110 and an enterprise 302, untrusted destination 308 and trusted destination 308 after a session has been established. The communication network 300 includes the enterprise 302 that controls the enterprise resource 102, the ZTNA broker 106, the hardware ZTNA enabled device 110, an underlay network 304, an overlay network 306, the untrusted destination 308 and the trusted destination 310. In some examples, all traffic to the OS 112 of the hardware ZTNA enabled device 110 is processed by the ZTNA NIC 114. In some examples, the ZTNA NIC 114 performs at least traffic filtering, inline inspection, encapsulation, and/or policy enforcement. A first traffic flow 312 between the enterprise 302 and the hardware ZTNA enabled device 110 communicates with the ZTNA NIC 114 via the underlay network 304. In the illustrated example, the first traffic flow 312 goes through the ZTNA broker 106. In other examples, the first traffic flow 312 flows directly to the ZTNA NIC 114 via the underlay 304 without passing through the ZTNA broker 106. In the illustrated example, the ZTNA NIC 114 performs all underlay 304 network functionality such as dynamic host configuration protocol (DHCP), address resolution protocol (ARP) and the ability to connect to Hotspot 2.0 and other hot spots versions. The ZTNA NIC processes the traffic and forwards traffic to the OS 112 in the overlay network 306.

A second traffic flow 314 between the hardware ZTNA enabled device 110 and the untrusted destination 308 flows through the ZTNA broker 106. In some examples, all traffic to or from the untrusted destination 308 are routed through the ZTNA broker 106. A third traffic flow 316 between the hardware ZTNA enabled device 110 and the trusted destination 310 flows directly from the hardware ZTNA enabled device 110 via the underlay network 304 without being routed through the ZTNA broker 106. In some examples, the ZTNA NIC 114 determines whether the hardware ZTNA enabled device 110 is in secure mode or non-secure mode. In those examples, the ZTNA NIC 114 may route the third traffic flow 316 through the ZTNA broker 106 when the hardware ZTNA enabled device 110 is in non-secure mode.

FIG. 4 is a flowchart representative of example machine readable instructions and/or example operations 400 that may be executed, instantiated, and/or performed by programmable circuitry to initialize the hardware-based ZTNA agent 101. The example machine-readable instructions and/or the example operations 400 of FIG. 3 begin at block 402, at which the ZTNA policy receiver circuitry 202 receives policies from the ZTNA broker 106. In some cases, the hardware-based ZTNA agent 101 is configured according to ZTNA policies. In some examples, authorization of the ZTNA backend is provided as part of initial setup. In other examples, the authorization of the ZTNA backend is provisioned later as part of acceptance of devices into an enterprise. At block 404, the traffic controller circuitry 208 offboards basic network connectivity functionality to an underlay network. The basic network connectivity functionality includes DHCP, ARP and the ability to connect to Hotspot 2.0 and other hot spots versions. At block 406, the virtual NIC exposer circuitry 204 exposes a virtual network (LAN) on an ‘overlay’ network into the OS to be used by the OS and software. In some examples, the virtual NIC exposed to the OS has a fixed IP address (pre-allocated) to help with incoming connections and to support persistent connections. At block 408, the traffic controller circuitry 208 gates internet connectivity using Wifi/LAN or derived from Hotspot 2.0. Block 408 includes setting up local traffic types like ARP, DHCP and HS 2.0 traffic. In some examples, to address captive portal, the traffic controller circuitry 208 uses a reverse proxy or an embedded web server such that the entry form is handled “below OS.” All configurations run below the OS.

FIG. 5 is a flowchart representative of example machine readable instructions and/or example operations 500 that may be executed, instantiated, and/or performed by programmable circuitry to implement the hardware-based ZTNA agent 101. The example machine-readable instructions and/or the example operations 500 of FIG. 3 begin at block 502, at which the security circuitry 206 receives a request from the hardware ZTNA enabled device 110 to access the enterprise resource 102. In some examples, the request is received via the ZTNA interface. At block 504, the security circuitry 206 determines whether the hardware ZTNA enabled device 110 is authorized to access the enterprise resource 102 based on an identity of the hardware ZTNA enabled device 110, the security posture of the hardware ZTNA enabled device 110, and/or a security policy. If the hardware ZTNA enabled device 110 is not authorized to access the enterprise resource 102 (e.g., block 504 returns a result of NO), the traffic controller circuitry 208 restricts access to the enterprise resource 102 (block 506). If the hardware ZTNA enabled device 110 is authorized to access the enterprise resource 102 (e.g., block 504 returns a result of YES), the traffic controller circuitry 208 establishes a connection between the hardware ZTNA enabled device 110 and the enterprise resources 102 (block 508). After the connection is established, the traffic controller circuitry 208 determines whether the hardware ZTNA enabled device 110 is in a secure mode at block 510. If the hardware ZTNA enabled device 110 is not in a secured mode (e.g., block 510 returns a result of NO), the traffic controller circuitry 208 blocks or redirects all traffic externally based on policy (block 512). If the hardware ZTNA enabled device 110 is in a secured mode (e.g., block 510 returns a result of YES), the traffic controller circuitry 208 determines whether the backend policy allows trusted destinations at block 514. If the policy allows trusted destinations (e.g., block 510 returns a result of YES), the traffic controller allows direct traffic to trusted destinations (block 516). If the policy does not allow trusted destinations (e.g., block 510 returns a result of NO), the traffic controller blocks or redirects all traffic to the ZTNA broker 106 based on policy (block 518). In some examples, the example operations 500 include dropping all traffic that isn't IPSEC/TLS. Traffic other than an initial connection to web will either go to known POPs or other trusted destinations.

FIG. 6 is a block diagram of an example programmable circuitry platform 600 structured to execute and/or instantiate the example machine-readable instructions and/or the example operations of FIGS. 4-5 to implement the hardware-based ZTNA agent 101 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the ZTNA policy receiver circuitry 202, the virtual NIC exposer circuitry 204, the security circuitry 206, and the traffic controller circuitry 208.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4-5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 4-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 4-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 4-5. As such, the FPGA circuitry 800 may be configured and/or structured to effectively instantiate some or all of the operations/functions corresponding to the machine readable instructions of the flowcharts of FIGS. 4-5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowcharts of FIGS. 4-5 to perform first operation(s)/function(s), the FPGA circuitry 800 of FIG. 8 may be configured and/or structured to perform second operation(s)/function(s) corresponding to a second portion of the machine readable instructions represented by the flowcharts of FIG. 4-5, and/or an ASIC may be configured and/or structured to perform third operation(s)/function(s) corresponding to a third portion of the machine readable instructions represented by the flowcharts of FIGS. 4-5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

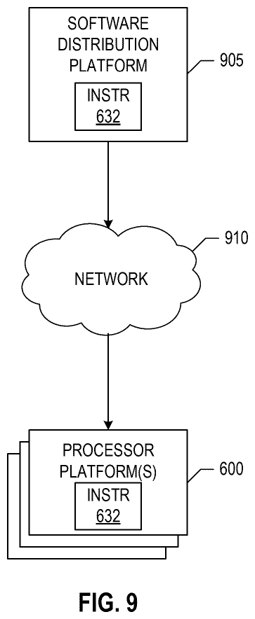

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 4-5, may be downloaded to the example programmable circuitry platform 600, which is to execute the machine readable instructions 632 to implement the hardware-based ZTNA agent 101. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide for a ZTNA agent with core functionality implemented below the OS, providing improved protection from OS attackers and improving performance and connectivity compared to existing solutions.

Disclosed systems, apparatus, articles of manufacture, and methods improve the efficiency of using a computing device by offloading key performance-impacting functions such as packet encapsulation and filtering to dedicated hardware for improved efficiency. Disclosed systems, apparatus, articles of manufacture, and methods are accordingly directed to one or more improvement(s) in the operation of a machine such as a computer or other electronic and/or mechanical device.

Further examples and combinations thereof include the following:
Example 1 includes an apparatus including network interface circuitry; machine-readable instructions; and first processor circuitry programmable by the instructions to detect, via firmware execution, a request from a device to access a resource via a zero trust network access interface; determine, via the firmware execution, a security state of the device; and based on the security state of the device, transmit the request to a host operating system (OS) via a virtual network interface, the operating system executed via second processor circuitry different than the first processor circuitry.
Example 2 includes the apparatus of example 1, wherein the first processor circuitry is to process network communication directed to and from the host OS.
Example 3 includes the apparatus of any of examples 1 or 2, wherein the virtual network interface circuitry controls traffic directed to and from the host OS.
Example 4 includes the apparatus of any of examples 1-3, wherein the first processor circuitry is to enforce a security policy of a zero trust network access provider to control traffic to and from the host OS.
Example 5 includes the apparatus of any of examples 1-4, wherein the first processor circuitry is to provide the host OS access to a first network and prohibit access to the first network via the virtual network interface.
Example 6 includes the apparatus of any of examples 1-5, wherein the first processor circuitry is to determine the host OS is subject to a malicious operating system attack; and restrict traffic directed to and from the host OS.
Example 7 includes the apparatus of any of examples 1-6, wherein the first processor circuitry is to allow a first portion of traffic from the device to flow to the host OS via the virtual network interface; and perform a security inspection of a second portion of traffic from the device.
Example 8 includes the apparatus of any of examples 1-7, wherein the first processor circuitry is to determine a destination of traffic from the host OS resource is a trusted destination based on a policy of a zero trust network access provider; and cause the second processor circuitry to forward the traffic to the destination without going through the zero trust network access provider.
Example 9 includes the apparatus of any of examples 1-8, wherein the first processor circuitry performs a first portion of network and security processing and a zero trust network access provider performs a second portion of network and security processing.
Example 10 includes at least one non-transitory computer readable medium comprising machine-readable instructions that, when executed, cause at least one processor circuit to at least: detect, via firmware execution, a request from a device to access a resource via a zero trust network access interface; determine, via the firmware execution, a security state of the device; and based on the security state of the device, transmit the request to a host operating system (OS) via a virtual network interface, the operating system executed via processor circuitry different than the at least one processor circuit.
Example 11 includes the storage medium of example 10, wherein the machine-readable instructions are to cause one or more of the at least one processor circuit to process network communication directed to and from the host OS.
Example 12 includes the storage medium of any of examples 10 or 11, wherein the virtual network interface circuitry controls traffic directed to and from the host OS.
Example 13 includes the storage medium of any of examples 10-12, wherein the machine-readable instructions are to cause one or more of the at least one processor circuit to enforce a security policy of a zero trust network access provider to control traffic to and from the host OS.
Example 14 includes the storage medium of any of examples 10-13, wherein the machine-readable instructions are to cause one or more of the at least one processor circuit to provide the host OS access to a first network and prohibit access to the first network via the virtual network interface.
Example 15 includes the storage medium of any of examples 10-14, wherein the machine-readable instructions are to cause one or more of the at least one processor circuit to determine the host OS is subject to a malicious operating system attack; and restrict traffic directed to and from the host OS.
Example 16 includes the storage medium of any of examples 10-15, wherein the machine-readable instructions are to cause one or more of the at least one processor circuit to allow a first portion of traffic from the device to flow to the host OS via the virtual network interface; and perform a security inspection of a second portion of traffic from the device.
Example 17 includes the storage medium of any of examples 10-16, wherein the machine-readable instructions are to cause one or more of the at least one processor circuit to determine a destination of traffic from the host OS is a trusted destination based on a policy of a zero trust network access provider; and cause the second processor circuitry to forward the traffic to the destination without going through the zero trust network access provider.
Example 18 includes the storage medium of any of examples 10-17, wherein the machine-readable instructions are to cause one or more of the at least one processor circuit to perform a first portion of network and security processing and a zero trust network access provider performs a second portion of network and security processing.
Example 19 includes a method including detecting, via firmware executed by at least one processor circuit programmed by at least one instruction, a request from a device to access a resource via a zero trust network access interface; determining, via the firmware execution, a security state of the device; and based on the security state of the device, transmitting the request to a host operating system (OS) via a virtual network interface, the operating system executed via second processor circuitry different than the at least one processor circuit.
Example 20 includes the method of example 19, further including determining a destination of traffic from the host OS resource is a trusted destination based on a policy of a zero trust network access provider; and causing the processor circuitry to forward the traffic to the destination without going through the zero trust network access provider.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
network interface circuitry;
machine-readable instructions; and
first processor circuitry programmable by the instructions to:
detect, via firmware execution, a request from a device to access a resource via a zero trust network access interface;
determine, via the firmware execution, a security state of the device; and
based on the security state of the device, transmit the request to a host operating system (OS) via a virtual network interface, the operating system executed via second processor circuitry different than the first processor circuitry.

2. The apparatus of claim 1, wherein the first processor circuitry is to process network communication directed to and from the host OS.

3. The apparatus of claim 1, wherein the virtual network interface circuitry controls traffic directed to and from the host OS.

4. The apparatus of claim 3, wherein the first processor circuitry is to enforce a security policy of a zero trust network access provider to control traffic to and from the host OS.

5. The apparatus of claim 4, wherein the first processor circuitry is to provide the host OS access to a first network and prohibit access to the first network via the virtual network interface.

6. The apparatus of claim 1, wherein the first processor circuitry is to:
determine the host OS is subject to a malicious operating system attack; and
restrict traffic directed to and from the host OS.

7. The apparatus of claim 1, wherein the first processor circuitry is to:
allow a first portion of traffic from the device to flow to the host OS via the virtual network interface; and
perform a security inspection of a second portion of traffic from the device.

8. The apparatus of claim 1, wherein the first processor circuitry is to:
determine a destination of traffic from the host OS resource is a trusted destination based on a policy of a zero trust network access provider; and
cause the second processor circuitry to forward the traffic to the destination without going through the zero trust network access provider.

9. The apparatus of claim 1, wherein the first processor circuitry performs a first portion of network and security processing and a zero trust network access provider performs a second portion of network and security processing.

10. At least one non-transitory machine-readable medium comprising machine-readable instructions to cause at least one processor circuit to at least:
detect, via firmware execution, a request from a device to access a resource via a zero trust network access interface;
determine, via the firmware execution, a security state of the device; and
based on the security state of the device, transmit the request to a host operating system (OS) via a virtual network interface, the operating system executed via processor circuitry different than the at least one processor circuit.

11. The at least one non-transitory machine-readable medium of claim 10, wherein the machine-readable instructions are to cause one or more of the at least one processor circuit to process network communication directed to and from the host OS.

12. The at least one non-transitory machine-readable medium of claim 10, wherein the virtual network interface circuitry controls traffic directed to and from the host OS.

13. The at least one non-transitory machine-readable medium of claim 12, wherein the machine-readable instructions are to cause one or more of the at least one processor circuit to enforce a security policy of a zero trust network access provider to control traffic to and from the host OS.

14. The at least one non-transitory machine-readable medium of claim 13, wherein the machine-readable instructions are to cause one or more of the at least one processor circuit to provide the host OS access to a first network and prohibit access to the first network via the virtual network interface.

15. The at least one non-transitory machine-readable medium of claim 10, wherein the machine-readable instructions are to cause one or more of the at least one processor circuit to:
determine the host OS is subject to a malicious operating system attack; and
restrict traffic directed to and from the host OS.

16. The at least one non-transitory machine-readable medium of claim 10, wherein the machine-readable instructions are to cause one or more of the at least one processor circuit to:
allow a first portion of traffic from the device to flow to the host OS via the virtual network interface; and
perform a security inspection of a second portion of traffic from the device.

17. The at least one non-transitory machine-readable medium of claim 10, wherein the machine-readable instructions are to cause one or more of the at least one processor circuit to:
determine a destination of traffic from the host OS is a trusted destination based on a policy of a zero trust network access provider; and
cause the second processor circuitry to forward the traffic to the destination without going through the zero trust network access provider.

18. The at least one non-transitory machine-readable medium of claim 10, wherein the machine-readable instructions are to cause one or more of the at least one processor circuit to perform a first portion of network and security processing and a zero trust network access provider performs a second portion of network and security processing.

19. A method comprising:
detecting, via firmware executed by at least one processor circuit programmed by at least one instruction, a request from a device to access a resource via a zero trust network access interface;
determining, via the firmware execution, a security state of the device; and
based on the security state of the device, transmitting the request to a host operating system (OS) via a virtual network interface, the operating system executed via second processor circuitry different than the at least one processor circuit.

20. The method of claim 19, further including:
determining a destination of traffic from the host OS resource is a trusted destination based on a policy of a zero trust network access provider; and
causing the processor circuitry to forward the traffic to the destination without going through the zero trust network access provider.
